(19) United States
(12) Patent Application Publication
(10) Pub. No.: US 2023/0345095 A1
(43) Pub. Date: Oct. 26, 2023

(54) ISLA THERMAL TRANSFER TO SUB-SYSTEM BASE

(71) Applicant: GoPro, Inc., San Mateo, CA (US)

(72) Inventors: Adrian Santos, Dublin, CA (US); Nicholas Vitale, Foster City, CA (US); Joseph Tucker, Foster City, CA (US)

(21) Appl. No.: 17/726,181

(22) Filed: Apr. 21, 2022

(51) Int. Cl. H04N 5/225; G03B 17/55

(52) U.S. Cl. CPC H04N 5/22521; H04N 5/2254; H04N 5/2252; H04N 5/2253; G03B 17/55

(57) ABSTRACT

The image capture device includes a receptacle defined within a housing and an optic system that is removably connect with the receptacle and to generate thermal energy. The image capture device includes a heatsink positioned at a base of the receptacle. The heatsink includes an inner support positioned within the housing and an outer support in thermal communication with the optic system and the inner support. The heatsink further includes a gasket integrated with the receptacle to form a watertight seal, sandwiched between portions of the inner and outer supports, and flexibly retaining a physical connection between the optic system and the outer support.

### TECHNICAL FIELD

This disclosure relates to a heatsink useable to transfer heat between two separable components in an image capture device.

### BACKGROUND

Generally, image capture devices are available that are capable of capturing both images and videos. These image capture devices may include lenses that may be changed in order to change a field of view, increase or decrease magnification, or otherwise enhance image capture for the image capture devices. Thus, a user may select a lens and place a different lens on an image capture device to create a desired effect. Cameras with interchangeable systems generate a considerable amount of heat in one or both of the components. What is needed are new systems to distribute heat within a camera so that usage time can be prolonged and more videos and/or images can be captured.

### SUMMARY

Disclosed herein are implementations of an image capture device. The image capture device includes a receptacle defined within a housing and an optic system that is removably connect with the receptacle and to generate thermal energy. The image capture device includes a heatsink positioned at a base of the receptacle. The heatsink includes an inner support positioned within the housing and an outer support in thermal communication with the optic system and the inner support. The heatsink further includes a gasket integrated with the receptacle to form a watertight seal, sandwiched between portions of the inner and outer supports, and flexibly retaining a physical connection between the optic system and the outer support.

The image capture device may further include a locking feature that releasably secures the optic system within the receptacle and an electrical connection that is spaced a distance from locking feature. The electrical connection may facilitate communication between the housing and the optic system. The outer support of the heatsink may regulate thermal energy between the inner support and the receptacle, and the inner support may dissipate thermal energy. The image capture device may further include a heat exchange that dissipates thermal energy and a compression member in contact with the inner support that provides a compressive force against the heat exchange and/or the inner support. The image capture device may further include a conductor that thermally connects the heat exchange and an internal component that is separated a distance from the heat exchange and is within the housing. The internal component may dissipate thermal energy. The image capture device may include a conductor that thermally connects the inner support and a heat exchange that is separated a distance from the inner support and is within the housing. The optic device may further include an optical component that is configured to generate thermal energy, a heat exchange contactable with the outer support, and a conductor that connects and regulates thermal energy between the optical component and the heat exchange. The optical component may include an imaging sensor.

Disclosed herein are implementations of an image capture device that includes a receptacle, which receives an optic system that is removable, and a heatsink that is defined within the receptacle and is in thermal communication with the optic system. The heatsink includes inner and outer supports that are each in thermal communication with the optic system and a gasket positioned between one or more portions of each of the inner and outer supports. The gasket forces contact between the outer support and the optic system.

The gasket may be integrated with a base of the receptacle to form a watertight seal between the receptacle and an external environment. The image capture device may further include an internal component configured to dissipate thermal energy, positioned within a housing of the image capture device, and spaced a distance from the heatsink. The image capture device may further include a conductor that connects the internal component and the heatsink. The image capture device may further include a heat exchange that is anchored to an internal surface of the receptacle and dissipates thermal energy. The image capture device may further include a compression member in contact with the inner support and the heat exchange, and the compression member may provide a compression force against the heat exchange and/or the inner support. The image capture device may further include a conductor that connects the heat exchange or the inner support with an internal component, and the internal component may be positioned within a housing of the image capture device, be spaced a distance from the heat exchange and the inner support, and dissipate thermal energy. The outer support may be positioned to contact the optic system and regulate thermal energy between the optic system and the inner support.

Disclosed are implementations of an image capture device that include a housing, which defines a receptacle, and an optic system removably connected to the receptacle that generates thermal energy. The image capture device includes a heatsink that is defined within a base of the receptacle, and the heatsink provides a compressive force against the optic system when the optic system is connected with the receptacle and to regulate thermal energy between the optic system and the housing.

The heatsink may include a gasket integrated with the base of the receptacle to form a watertight seal that provides the compressive force against the optic system. The heatsink may include inner and outer supports that sandwich a portion of the gasket that regulate thermal energy between the optic system and the housing. The heatsink may include a heat exchange that is in contact with the inner support and is configured to dissipate thermal energy. The heatsink may include a compression member that provides a force against the heat exchange and the inner support when compressed. The heatsink may be partially exposed to an external environment and may contact the optical system. The image capture device may further include a conductor that extends between the heatsink and an internal component that is spaced a distance from the heatsink within the housing. The optic system may include an imaging sensor and a conductor that includes at least one surface that is exposed to the receptacle and that connects the imaging sensor and the heatsink.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIG. 2 is a block diagram of electronic components of an image capture device.

FIG. 3A is a front isometric view of an optic system and the housing.

FIG. 3B is a rear isometric view of the optic system and the housing of FIG. 3A.

FIG. 3C is a partial exploded view of the optic system and the housing of FIG. 3A.

FIG. 4 is a cross-sectional view of an example of an image capture device 400 of FIG. 3A along lines IV-IV.

FIG. 5 is a cross-sectional view of another example of the optic system and the housing of FIG. 3A along lines IV-IV.

FIG. 6 is a cross-sectional view of another example of the optic system and the housing of FIG. 3A along lines IV-IV.

FIG. 7 is a cross-sectional view of another example of the optic system and the housing of FIG. 3A along lines IV-IV.

### DETAILED DESCRIPTION

The present teachings provide an image capture device including a heatsink that is incorporated with an exterior surface of the housing. The interchangeable lens generally includes a sensor, among other components, that generates considerable heat during operation, and the image capture device can include multiple processors which also generate considerable heat. At a point of contact between interchangeable lens and the housing, the heatsink is positioned to regulate energy between the interchangeable lens and the housing and, additionally, provide a flexible force against the interchangeable lens. An opposing force from the housing, such as a locking feature, retains the interchangeable lens against the housing. With this flexible force and opposing force, the heatsink will remain in physical contact with the heat regulating elements of the interchangeable lens, even when the components do not have a perfect machine fit. This is advantageous to provide manufactures more room for variation when producing parts because the flexible force, which may be generated by a gasket or the like, will push the heatsink against the interchangeable lens. Thus, optimal heat transfer will persist between the interchangeable lens and the housing, and the image capture device can operate for longer periods of time without overheating.

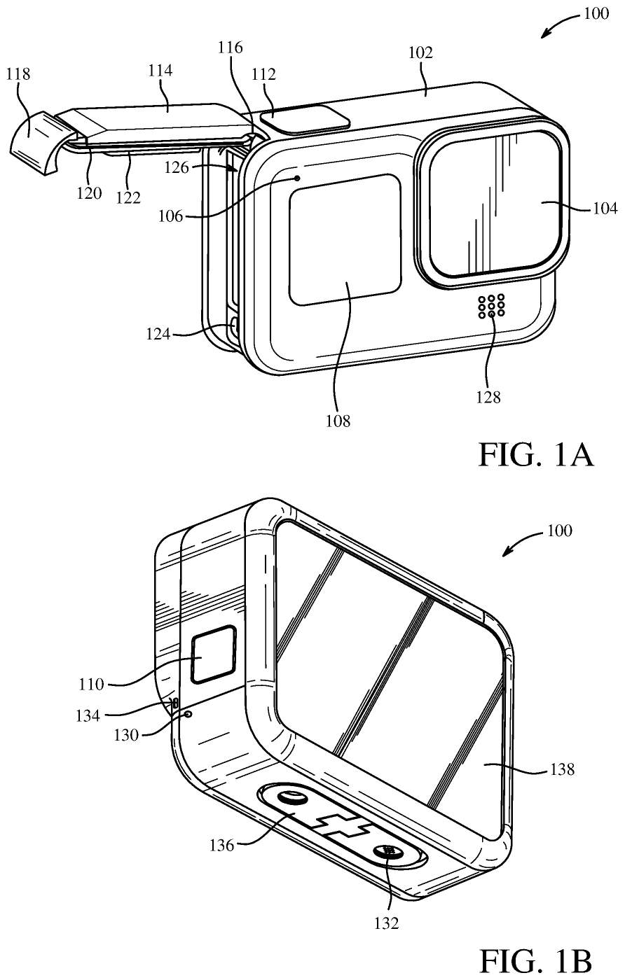

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

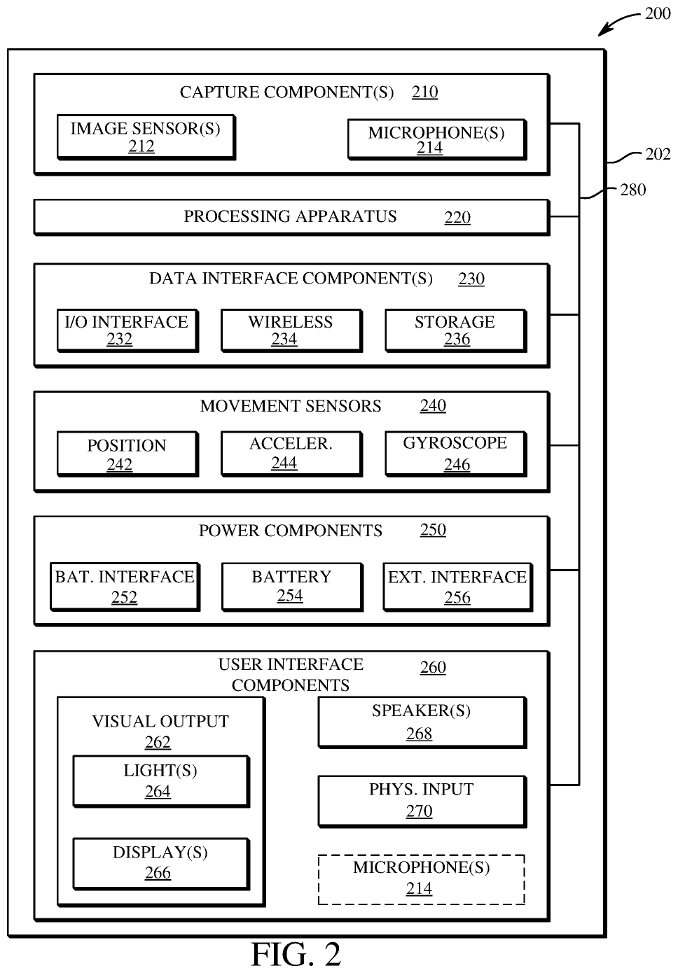

FIG. 2 is a block diagram of electronic components in an image capture device 200. The image capture device 200 may be a single-lens image capture device, a multi-lens image capture device, or variations thereof, including an image capture device with multiple capabilities such as use of interchangeable integrated sensor lens assemblies. The description of the image capture device 200 is also applicable to the image capture device 100 of FIGS. 1A-B.

The image capture device 200 includes a body 202 which includes electronic components such as capture components 210, a processing apparatus 220, data interface components 230, movement sensors 240, power components 250, and/or user interface components 260.

The capture components 210 include one or more image sensors 212 for capturing images and one or more microphones 214 for capturing audio.

The image sensor(s) 212 is configured to detect light of a certain spectrum (e.g., the visible spectrum or the infrared spectrum) and convey information constituting an image as electrical signals (e.g., analog or digital signals). The image sensor(s) 212 detects light incident through a lens coupled or connected to the body 202. The image sensor(s) 212 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 212 may be passed to other electronic components of the image capture device 200 via a bus 280, such as to the processing apparatus 220. In some implementations, the image sensor(s) 212 includes a digital-to-analog converter. A multi-lens variation of the image capture device 200 can include multiple image sensors 212.

The microphone(s) 214 is configured to detect sound, which may be recorded in conjunction with capturing images to form a video. The microphone(s) 214 may also detect sound in order to receive audible commands to control the image capture device 200.

The processing apparatus 220 may be configured to perform image signal processing (e.g., filtering, tone mapping, stitching, and/or encoding) to generate output images based on image data from the image sensor(s) 212. The processing apparatus 220 may include one or more processors having single or multiple processing cores. In some implementations, the processing apparatus 220 may include an application specific integrated circuit (ASIC). For example, the processing apparatus 220 may include a custom image signal processor. The processing apparatus 220 may exchange data (e.g., image data) with other components of the image capture device 200, such as the image sensor(s) 212, via the bus 280.

The processing apparatus 220 may include memory, such as a random-access memory (RAM) device, flash memory, or another suitable type of storage device, such as a non-transitory computer-readable memory. The memory of the processing apparatus 220 may include executable instructions and data that can be accessed by one or more processors of the processing apparatus 220. For example, the processing apparatus 220 may include one or more dynamic random-access memory (DRAM) modules, such as double data rate synchronous dynamic random-access memory (DDR SDRAM). In some implementations, the processing apparatus 220 may include a digital signal processor (DSP). More than one processing apparatus may also be present or associated with the image capture device 200.

The data interface components 230 enable communication between the image capture device 200 and other electronic devices, such as a remote control, a smartphone, a tablet computer, a laptop computer, a desktop computer, or a storage device. For example, the data interface components 230 may be used to receive commands to operate the image capture device 200, transfer image data to other electronic devices, and/or transfer other signals or information to and from the image capture device 200. The data interface components 230 may be configured for wired and/or wireless communication. For example, the data interface components 230 may include an I/O interface 232 that provides wired communication for the image capture device, which may be a USB interface (e.g., USB type-C), a high-definition multimedia interface (HDMI), or a FireWire interface. The data interface components 230 may include a wireless data interface 234 that provides wireless communication for the image capture device 200, such as a Bluetooth interface, a ZigBee interface, and/or a Wi-Fi interface. The data interface components 230 may include a storage interface 236, such as a memory card slot configured to receive and operatively couple to a storage device (e.g., a memory card) for data transfer with the image capture device 200 (e.g., for storing captured images and/or recorded audio and video).

The movement sensors 240 may detect the position and movement of the image capture device 200. The movement sensors 240 may include a position sensor 242, an accelerometer 244, or a gyroscope 246. The position sensor 242, such as a global positioning system (GPS) sensor, is used to determine a position of the image capture device 200. The accelerometer 244, such as a three-axis accelerometer, measures linear motion (e.g., linear acceleration) of the image capture device 200. The gyroscope 246, such as a three-axis gyroscope, measures rotational motion (e.g., rate of rotation) of the image capture device 200. Other types of movement sensors 240 may also be present or associated with the image capture device 200.

The power components 250 may receive, store, and/or provide power for operating the image capture device 200. The power components 250 may include a battery interface 252 and a battery 254. The battery interface 252 operatively couples to the battery 254, for example, with conductive contacts to transfer power from the battery 254 to the other electronic components of the image capture device 200. The power components 250 may also include an external interface 256, and the power components 250 may, via the external interface 256, receive power from an external source, such as a wall plug or external battery, for operating the image capture device 200 and/or charging the battery 254 of the image capture device 200. In some implementations, the external interface 256 may be the I/O interface 232. In such an implementation, the I/O interface 232 may enable the power components 250 to receive power from an external source over a wired data interface component (e.g., a USB type-C cable).

The user interface components 260 may allow the user to interact with the image capture device 200, for example, providing outputs to the user and receiving inputs from the user. The user interface components 260 may include visual output components 262 to visually communicate information and/or present captured images to the user. The visual output components 262 may include one or more lights 264 and/or more displays 266. The display(s) 266 may be configured as a touch screen that receives inputs from the user. The user interface components 260 may also include one or more speakers 268. The speaker(s) 268 can function as an audio output component that audibly communicates information and/or presents recorded audio to the user. The user interface components 260 may also include one or more physical input interfaces 270 that are physically manipulated by the user to provide input to the image capture device 200. The physical input interfaces 270 may, for example, be configured as buttons, toggles, or switches. The user interface components 260 may also be considered to include the microphone(s) 214, as indicated in dotted line, and the microphone(s) 214 may function to receive audio inputs from the user, such as voice commands.

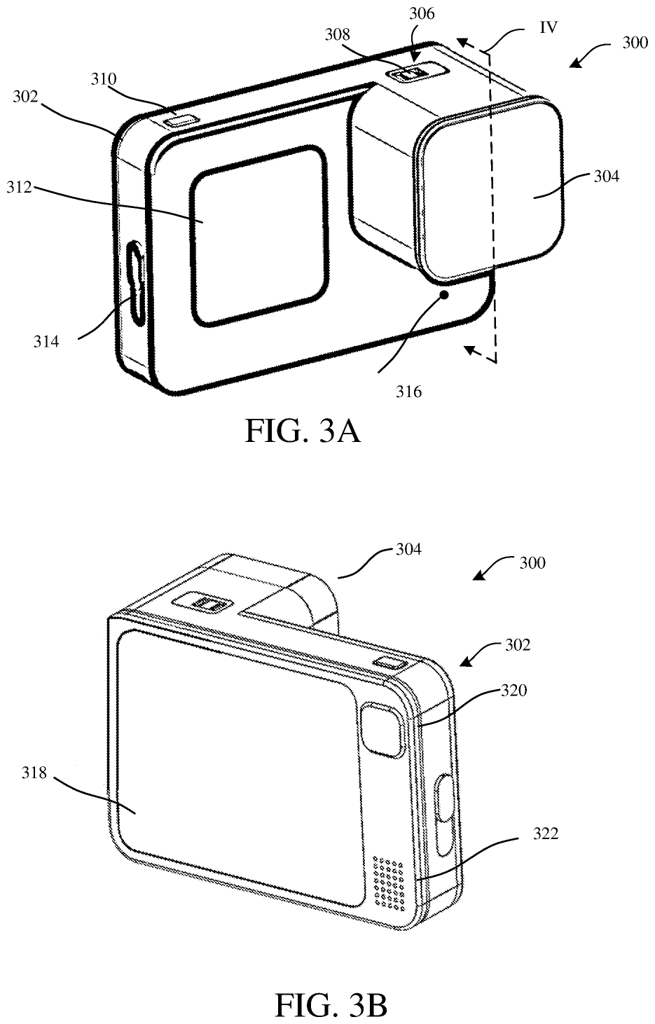

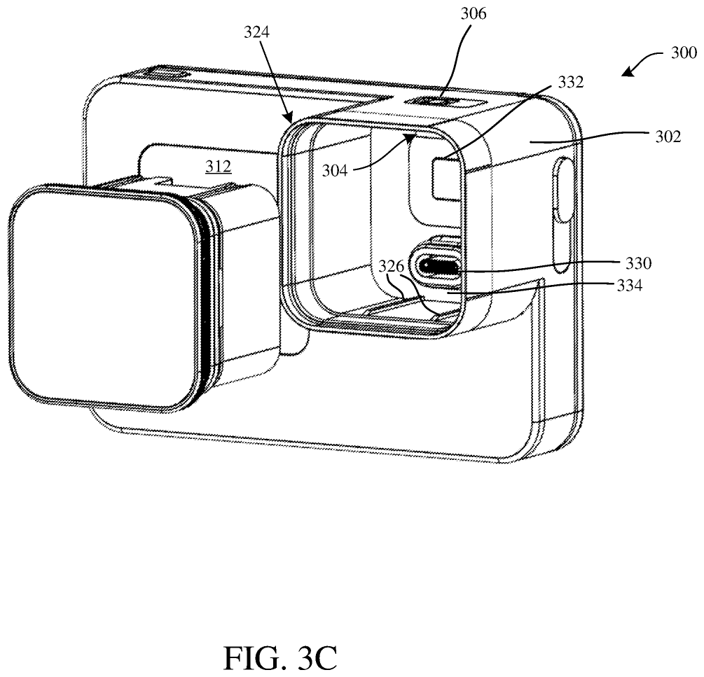

The image capture devices 100, 200 may be configured in the form of an image head and may connect with various form factor sub-system bases as described in FIGS. 3A-6F.

FIG. 3A is a front isometric view of an image capture device 300. The image capture device 300 includes a housing 302 which as shown has a phone-like form factor (i.e., a base, a sub-system base, or phone-like base) and an optic system 304. A locking mechanism 306 includes a switch 308 that removably connects the optic system 304 within the housing 302. For example, when a user desires to remove the optic system 304 from the housing 302, the user moves or otherwise engages the switch 308 so that the optic system 304 may be pulled out of the housing 302.

The housing 302 includes a shutter button 310 that upon actuation can activate the optic system 304 so that the optic system 304 detects, generates, and/or otherwise captures an image (not shown). The image may be previewed on a front screen 312 before the image is saved or the image may be shown on the front screen 312 after the shutter button 310 is actuated. The front screen 312 may be used in a “selfie” mode or to show a user or subject of the image that the image has been or is being generated.

The housing 302 includes one or more ports 314. The ports 314 may be connected to one or more internal components of the housing 302, the optic system 304, or both. The ports 314 may be configured to support transfer of power, data, or both. The ports 314 may support charging internal batteries (e.g., one or more or two or more batteries). The ports 314 may provide access to data in the memory, receive data from the memory, or both. The ports 314 may be a USB, micro-USB, USB-A, USB-B, USB-C, an XLR, RCA, AC/DC power converter, or a combination thereof. The housing 302 may have multiple different ports 314 that each provide some different function or connect to a different part of the image capture device 300.

The housing 302 may include one or more microphones 316. The microphone 316 on the front surface is located below the optic system 304. The microphones 316 assist collecting sounds and noises produced while in video mode. The microphones 316 may include one or more, two or more, or three or more microphones. The microphones 316 may be located on a top, bottom, front, left, right, back, or a combination of sides of the image capture device 300.

FIG. 3B is a rear isometric view of the image capture device 300. The rear surface of the housing 302 is shown with the optic system 304 facing away from the viewer. A majority (e.g., 60 percent or more, 75 percent or more, 85 percent or more, or 90 percent or more by area) of the rear surface of the housing 302 is covered by a rear screen 318. The rear screen 318 may be used to preview images previously generated, preview images being generated, review memory settings, review system settings, review mode settings, or a combination thereof. The rear screen 318 may show a user what is in the view of the optic system 304. A user may actuate a toggle 320 to control contents of the rear screen 318.

The toggle 320 is a button that permits a user to select an item from a menu, a bar, a window, a tab, or a combination thereof. The toggle 320 may move from bar to bar, window to window, tab to tab, option to option, or a combination thereof. The toggle 320 may change from picture to picture. The toggle 320 may allow the user to change modes, adjust settings, adjust volume, or a combination thereof. The toggle 320 may control the image capture device 300. The toggle 320 may be an arrow button, an enter button, a joystick, a capacitive sensor, or a combination thereof. The toggle 320 as shown is located adjacent to a speaker 322.

One or more speakers 322 may produce sounds or replay recorded audio. The speakers 322 may indicate that a recording is in progress, a recording is about to occur, or both. The speakers 322 may replay audio captured during use of the optic system 304 (e.g., a video) or relay status information from the image capture device 300. The speakers 322 may be located on any side of the housing 302 (e.g., front, back, top, bottom, left, right, or a combination thereof). The housing 302 may include one or more speakers, two or more speakers, or even three or more speakers. The speakers 322 may only be located on the rear surface.

The housing 302 may include batteries (not shown). The batteries may include one or more batteries or two or more batteries. The batteries may provide sufficient power such that the image capture device 300 may operate for about 100 minutes or more, 200 minutes or more, 300 minutes or more, 350 minutes or more, 500 minutes or more, or 1000 minutes or more. The batteries may be lithium-ion rechargeable batteries.

FIG. 3C is a partially exploded view of the image capture device 300 with the optic system 304 removed from the housing 302. The optic system 304 is shown extending out of a receptacle 324 in the housing 302. The receptacle 324 is sized and shaped to fit substantially all of the optic system 304. The receptacle 324 may form an interference fit with the optic system 304 so that a watertight connection is formed. The receptacle 324 and the optic system 304 are complementary in shape. The receptacle 324 and optic system 304 may be any shape (e.g., square, rectangular, hexagonal, triangular, oval, round, pentagonal, octagonal, or a combination thereof) such that the receptacle 324 and optic system 304 are connectable together. The receptacle 324 may axially receive the optic system 304 and guide the optic system 304 into the receptacle 324. The receptacle 324 includes tracks 326 (lower portions of which are shown) that fit within rails 328 (upper portions of which are shown) on the optic system 304.

The tracks 326 and the rails 328 work in conjunction to seat the optic system 304 within the receptacle 324. The tracks 326 and the rails 328 provide sliding directional control to seat the optic system 304 within the receptacle 324. The sliding directional control between the tracks 326 and the rails 328 may provide directional support so that a user is not required to provide guidance during movement of the optic system 304 into the receptacle 324. The tracks 326 and the rails 328 may extend parallel to one another as shown, parallel to an axis of movement of the optic system 304, or both. The tracks 326 may include a raised surface that fits within voids, slots, or detents of the rails 328, or vice versa. There may be an equal number of the tracks 326 and the rails 328. One side of the optic system 304 may include two rails 328 and the corresponding side of the receptacle 324 may also include two tracks 326. The optic system 304 and the receptacle 324 may have a single track 326 and a single rail 328 that guide the optic system 304 into the receptacle 324. The rails 328 and the tracks 326 may have flat walls. The rails 328 and the tracks 326 may be “T” shaped so that the optic system 304 can only be installed in a certain configuration.

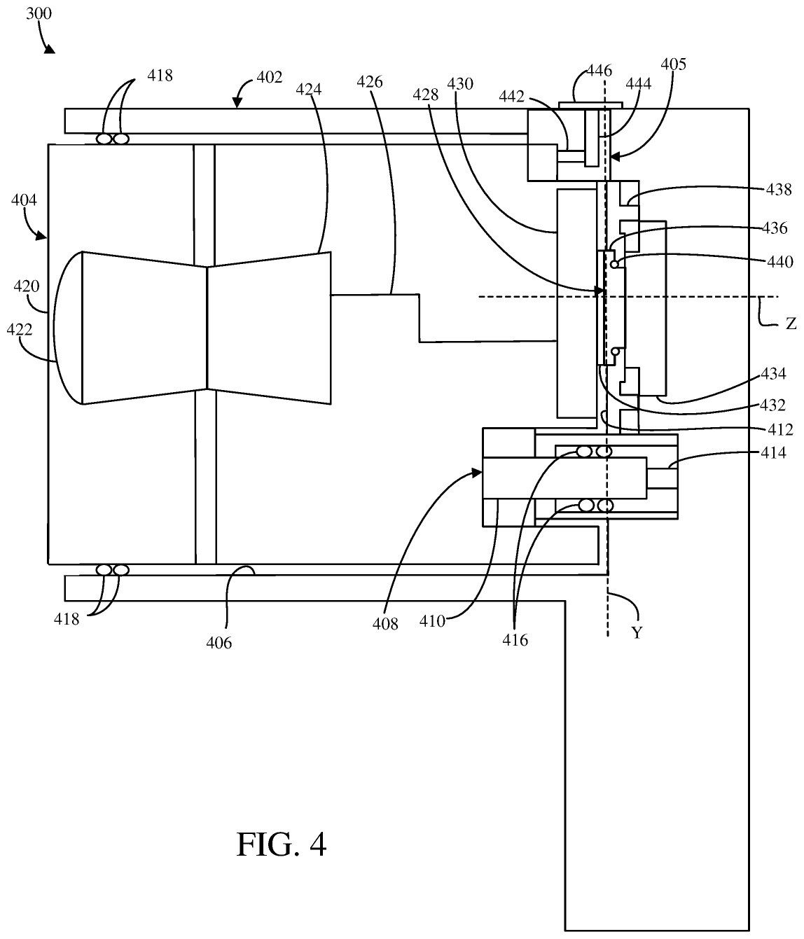

The rails 328 may have a larger opening (e.g., a flare as shown in FIGS. 6A-6B) and taper or narrow as the rails 328 extend from a rear end towards a forward end of the optic system 304. The rails 328 may include such a flared entrance or opening to assist in blindly inserting the optic system 304 into the receptacle 324. For example, as the optic system 304 is being inserted into the receptacle 324 a user's vision may be restricted such that the user cannot see the rails 328 or the tracks 326 to move the optic system 304 accordingly. The rails 328 may include a recess that the tracks 326 fit within. The tracks 326 and the rails 328 guide the optic system 304 axially into the receptacle 324 within the housing 302. The rails 328 may be located on one side. two sides, or more sides of the optic system 304. The rails 328 may be located on opposing sides or adjacent sides of the optic system 304. The rails 328 may guide the optic system 304 into the receptacle 324 so that an output (not shown) of the optic system 304 connects to an input 330 of the housing 302, a heatsink 332 of the housing 302, or both. Examples of different heatsinks are discussed in detail in the description of FIGS. 4-7.

The input 330 functions to electrically connect the housing 302 and the optic system 304. The input 330 may provide power to the optic system 304. The input 330 may provide signals to the front screen 312, the rear screen 318, or both. The input 330 and the ports 314 may include a same type of connector and the teachings of the ports 314 are incorporated herein as to the input 330. The input 330 may have some axial compliance so that the optic system 304 may be locked in place by the switch 308, be in communication with the heatsink 332, or both. The input 330 may be a male connector or a female connector. The input 330 may be a USB connector.

As the optic system 304 extends into the housing 302, a seal 334 within the receptacle 324 of the housing 302 is compressed so that a connection is formed between the input 330 and the optic system 304 and the seal 334 is compressed until the optic system 304 contacts heatsink 332. The seal 334 is a compliant material that may be compressed. The seal 334 may be compliant in one direction (e.g., axially) and rigid in a different direction (e.g., laterally). The seal 334 assists in supporting the input 330 so that the input 330 electrically connects to the optic system 304. The seal 334 may protect the input 330 or a region around the input 330 so that fluid, debris, or both are prevented from entering the housing 302 via the input 330. All or a portion of the seal 334 may extend into the input 330. The seal 334 may be compressed between the optic system 304 and a wall of the housing 302 so that a watertight seal is formed. The seal 334 may have some rigidity. The seal 334 may assist in supporting the input 330 so that the input 330 connects to the optic system 304. The seal 334 may be made of virtually any material that is hydrophobic and compliant. The seal 334 may be made of or include silicone, rubber, plastic, a polymer, an elastomer, a closed cell foam, or a combination thereof. The seal 334 may extend through the wall of the housing 302 to form a water barrier within the receptacle 324.

FIG. 4 is a cross-sectional view of an example of the image capture device 300 of FIG. 3A along lines IV-IV. The image capture device 300 includes a housing 402 and an optic system 404 that are releasably secured via a locking feature 405 that retains and/or secures the optic system 404 within a receptacle 406 of the housing 402. The locking feature 405 may provide a dual function of providing force that secures the housing 402 and the optic system 404 together and retains an electrical connection so that the optic system 404 remains in electronic communication with the housing 402 during operation but still allows for interchangeability of different optic systems (not shown), such as different optic systems with increased or decreased focus.

The housing 402 and the optic system 404 remain in electrical communication with each other via an electrical connection 408 that is positioned within the receptacle 406 and extends from the receptacle 406 in a perpendicular direction relative to a base 412 of the receptacle 406. The electrical connection 408 includes an output 410 secured to the optic system 404 and an input 414 secured to the housing 402, which in combination provide a means for sending electrical signals, power, and the like between the optic system 404 and the housing 402. In other examples, the output 410 may be secured to the housing 402, and the input 414 may be secured to the optic system 404, depending on the desired configuration of the housing 402 and the optic system 404.

The electrical connection 408 may function as an additional securing means between the housing 402 and the optic system 404 so that the housing 402 and the optic system have an interference fit. For example, the electrical connection 408 may work in combination with the locking feature 405 to secure the optic system 404 within the receptacle 406. In another example, the electrical connection 408 may connect the optic system 404 and the housing 402 in such a fashion that an external surface of the optic system 404 remains parallel relative to the base 412 and the receptacle 406.

Between the input 414 and the output 410, seals 416 are positioned to mitigate the entry of water to the electrical connection 408. The seals 416 may be secured to either the output 410 or the input 414, depending on whether seals 416 are desirable on the housing 402 or the optic system 404. Alternatively, the seals 416 may be split between the input 414 and the output 410 such that each includes at least one of the seals 416, which may improve the water mitigation effect (i.e., watertight seal) of the electrical connection 408. The seals 416 may be made of any material sufficient to block the flow of water between the receptacle 406 and the electrical connection 408. For example, the seals 416 may include one or more of natural rubbers, synthetic rubbers, or combination thereof.

Similarly, additional seals 418 are provided between the receptacle 406 and the optic system 404 so that water or moisture is mitigated within the receptacle 406 and does not reach the electrical connection 408. The seals 418 may be included with the optic system 404, the receptacle 406, or a combination of both, and the additional seals 418 may be provided further within the receptacle 406 to improve water mitigation from the external environment. Including multiple seals, such as the seals 416, 418, may be valuable where the image capture device 300 is being used in extreme conditions, such as underwater or in extreme weather/temperatures, so that the internal components do not get wet or are not exposed to extreme heats or colds. The seals 418 may be made of a similar or different material as the seals 416.

The housing 402 may function to receive or transfer thermal energy from or to the optic system 404. The housing 402 may include any internal or external component described in relation to the image capture devices 100, 200, 300 described in FIGS. 1-3C. For example, some of the components that are not shown but may be included in the housing 402 include a battery, a processor, a circuit board, a visual screen, microphones, speakers, conductors, GPS devices, additional heatsinks, or any combination thereof. Some or all of these components may be configured to generate heat that may be transferred to the optic system 404 so that operation time of the image capture device 300 is improved. In other examples, one or more of these components (not shown) may be connected with the optic system 404 so that heat can be spread to one or more the internal components of the housing 402 that are not shown.

The optic system 404 functions to capture images. The optic system 404 includes an external lens 420 that is configured to regulate light transfer to an internal lens 422. The internal lens 422 is directs light to an imaging sensor 424 that is configured to capture images through the external and internal lenses 420, 422. The imaging sensor 424 is configured to detect images via light that travels through the external and internal lenses 420, 422, and in the process of operating, the imaging sensor 424 generates considerable heat. The heat generated from the imaging sensor 424 is moved away from the imaging sensor 424 via a conductor 426 to the housing 402 so that the operation time of the imaging sensor 242 can be extended before the imaging sensor 424 reaches a temperature above a heat threshold.

In other examples, the optic system 404 can include any other component that generates heat which could inhibit the operation time of the image capture device 300 after extended operation time. For example, the optic system 404 may include a processor that works in conjunction with the imaging sensor 424. In another example, the optic system 404 may include a battery (not shown) that is connected through the conductor 426 or another conductor (not shown) to the housing 402.

Where interchangeable optic systems 404 are desired for use with the base 402, the optic system 404 may come in several variants. These variants may be designed to utilize more or fewer lenses depending on the desired optical features (e.g., such as focal length) of the particular interchangeable optic system 404. In other examples, a larger optic system (not shown) may be desirable to include a more powerful imaging sensor. When a pocket-sized image capture device is desired, a smaller optic system (not shown) may be used with the image capture device such that the optic system is wholly contained within the receptacle 406.

The housing 402 includes a heatsink 428 that functions to regulate heat between the housing 402 and the optic system 404. The heat generated from either of the housing 402 or the optic system 404 may be moved from one to the other by the heatsink 428. In this example, the imaging sensor 424 generates heat during operation of the image capture device 300, and the heatsink 428 transfers the heat through the conductor 426 into the housing 402 to improve operation times of the optic system 404. In other examples, an internal component of the housing 402, such as a processor or the like, may generate considerably more heat than all of the components of the optic system 404, and the heatsink 428 may move heat from one or more of the internal components to the optic system 404 so that operation of the image capture device 300 as a whole may be extended. With this configuration of the heatsink 428, operating times of the image capture device 300 as a whole can be extended by using all of the components of both the optic system 404 and the housing 402 in combination to dissipate heat.

The heatsink 428 is configured to remain in physical contact with the optic system 404 so that high surface area contact is retained between the optic system 404 and the heatsink 428. Specifically, the optic system 404 includes a heat exchange 430 that is connected with the imaging sensor 424 via the conductor 426. The heat exchange 430 is positioned on the optic system 404 such that a portion of the heat exchange 430 is exposed to the external environment. When exposed to the external environment and disposed within the receptacle 406, the heat exchange 430 directly contacts the heatsink 428 of the housing 402 and facilitates the movement of heat between the housing 402 and the optic system 404.

The heat exchange 430 may be wholly positioned within the optic system 404 such that only single surface of the heat exchange 430 is exposed to the external environment. In other examples, the heat exchange 430 may partially extend away, such as perpendicularly towards the heatsink 428, relative to the optic system 404 so that better surface contact is achieved between the heat exchange 430 and the heatsink 428. The heat exchange 430 in this case is wholly housed within the structure of the optic system 404, and the optic system 404 includes a thermal interface 432 that is positioned between the heat exchange 430 and the heatsink 428 to provide good thermal contact with the heatsink 428 and the heat exchange 430 while keeping the optic system 404 sealed against moisture. In other examples, no thermal interface 432 is included, and the heat exchange 430 is sealed against the optic system 404 by an adhesive or the like to reduce the number of components.

The heatsink 428 includes inner and outer supports 434, 436 that work in conjunction with a gasket 438 to keep the heatsink 428 in thermal contact with the heat exchange 430. The inner and outer supports 434, 436 sandwich around the gasket 438 such that when a force is applied to the heatsink 428, the gasket 438 deforms and moves in a direction driven by a location of application of the force. By deforming when a force is applied, the heatsink 428 can remain in thermal contact with an optic system 404 and another optic system (not shown) that is a slightly different length relative to the depth of the receptacle 406.

In other words, the flexibility of the gasket 438 provides a margin of error for the optic system 404 and the receptacle 406 so that each are compatible to form an interference fit. This margin of error may allow for optic systems (not shown) of varying lengths to be used, so long as the length is within about 0.5 percent to about 5 percent or more of the depth of the receptacle 406. For example, when the receptacle 406 has a depth of 100 units and the optic system 404 has a length of 95 units or 105 units, the optic system 404 and the receptacle 406 are still compatible to secure the optic system 404 within the receptacle 406 and to regulate heat through the heat exchange 430 and the heatsink 428 because the length and depth are within the margin of error.

The inner and outer supports 434, 436 function to regulate heat between the housing 402 and the optic system 404. The inner and outer supports 434, 436 may include any material sufficient to improve thermal transfer between components. For example, the inner and outer supports 434, 436 may include one or more of aluminum, gold, copper, ceramic, graphite, or any combination thereof. The inner and outer supports 434, 436 may be composed of the same or different materials, depending on the desired characteristics. For example, the outer support 436 may be made of a material or compound that is resistant to impacts from other components, such as the thermal interface 432, so that the outer support 436 does not crack or break as the optic system 404 is contacted with the outer support 436. In another example, the inner support 434 may be made of a material with superior conductivity properties so that heat is more efficiently transferred to one or more internal components of the housing 402.

The outer support 436 may be configured as having any shape sufficient to provide optimal thermal contact with the thermal interface 432. For example, if the thermal interface 432 is generally flat at its outer most surface, the outer support 436 may also be substantially flat at the surface facing the optic system 404. In other examples, the thermal interface 432 and the outer support 436 may be shaped such that the two components fit together in a lock and key configuration so that a user operating the image capture device 300 knows that the heatsink 428 is in proper thermal contact with the optic system 404 when the optic system 404 is installed in receptacle 406.

Around the gasket 438, the inner and outer supports 434, 436 prevent moisture or water from entering the housing 402 by sealing around the gasket 438 in a sandwich configuration. The gasket 438 is directly connected with the base 412 of the housing 402 such that the inner and outer supports 434, 436 are free of contact with the base 412. Specifically, the gasket 438 is in direct connection with the receptacle 406, and the inner and outer supports 434, 346 are positioned within an aperture of the gasket 348 and sandwiched around outer edges of the gasket 438. To increase water prevention qualities of the heatsink 428, a seal 440 is positioned between the gasket 438 and the outer support 436. The seal 440 may include similar materials or have a similar structure as the seals 416, 418. For additional prevention of water entry into the housing 402, the inner support 434 may also include a seal (not shown) that is in contact with the gasket 438. In other examples, both the inner and outer supports 434, 436 lack a seal.

In FIG. 4, the inner and outer supports 434, 436 are connected to the gasket 438 such that the inner and outer supports 434, 436 freely rotate, translate, or tilt relative to the base 412. In other configurations, the inner and/or outer supports 434, 436 may be connected with the housing 402 via an anchor or similar connection means that provides additional support to the inner and/or outer supports 434, 436 so long as the inner and/or outer supports 434, 436 have rotatability or translatability relative to the base 412. In some configurations, the inner and/or outer supports 434, 436 do not rotate, translate, or tilt relative to the base 412 and a non-rotatable and/or non-translate-able thermal connection between the optic system 404 and the housing 402 is desired. In an example where the inner and/or outer supports 434, 436 do not rotate, translate, or tilt relative to the base 412, the optic system 404 may include a gasket (not shown) or other flexible material that is similar to the gasket 438 so that the thermal interface 432 can rotate, tilt, or translate relative to the base 114 and align with the heatsink 428.

The free form configuration of the gasket 438, the inner support 434, and the outer support 436 allows the inner and outer supports 434, 436 to rotate or tilt relative to an X axis (not shown) and Y axis (Y) that is defined within the base 412. In other words, as the optic system 404 is moved linearly into the receptacle 406 along a Z axis (Z) and into contact with the base 412 so that the thermal interface 432 contacts the outer support 436, the outer support 436 can rotate, pivot, and/or translate along the X and Y axes so that optimal thermal contact between the outer support 436 and thermal interface 432 is achieved. For example, if the thermal interface 432 is tilted in some way relative to the base 412, a portion of the outer support 436 can rotate to match the tilt of the thermal interface 432.

The locking feature 405 functions to provide a releasable securing means to retain the optic system 404 within the receptacle 406. Additionally, the locking feature 405 in combination with the electrical connection 408 may function to align the heatsink 428 and the heat exchange 430 so that optimal transfer of heat occurs due to higher surface contact between the components. The optic system 404 includes a key 442 that is insertable into a retainer 444 of the locking feature 405. A switch 446 may be used to control when the retainer 444 releases the key 442 so that the optic system 404 can be removed from the receptacle 406. The key 442 and the retainer 444 may have any structure sufficient to form a releasable connection. For example, the key 442 may be configured as a clip that can insert one way into the retainer 444 that is configured as a slot. Upon activating the switch 446, the retainer 444 would release the key 442 and allow removal of the optic system 404. In other configurations, the locking feature 405 could be positioned anywhere on or in the receptacle 406. For example, the locking feature 405 may be configured as a collar-like retainer (not shown) that is interfaceable with the optic system 404 via a threaded connection that can be released and secured by rotating the collar relative to the optic system 404, in which case, the key 442 and the switch 446 would not be needed.

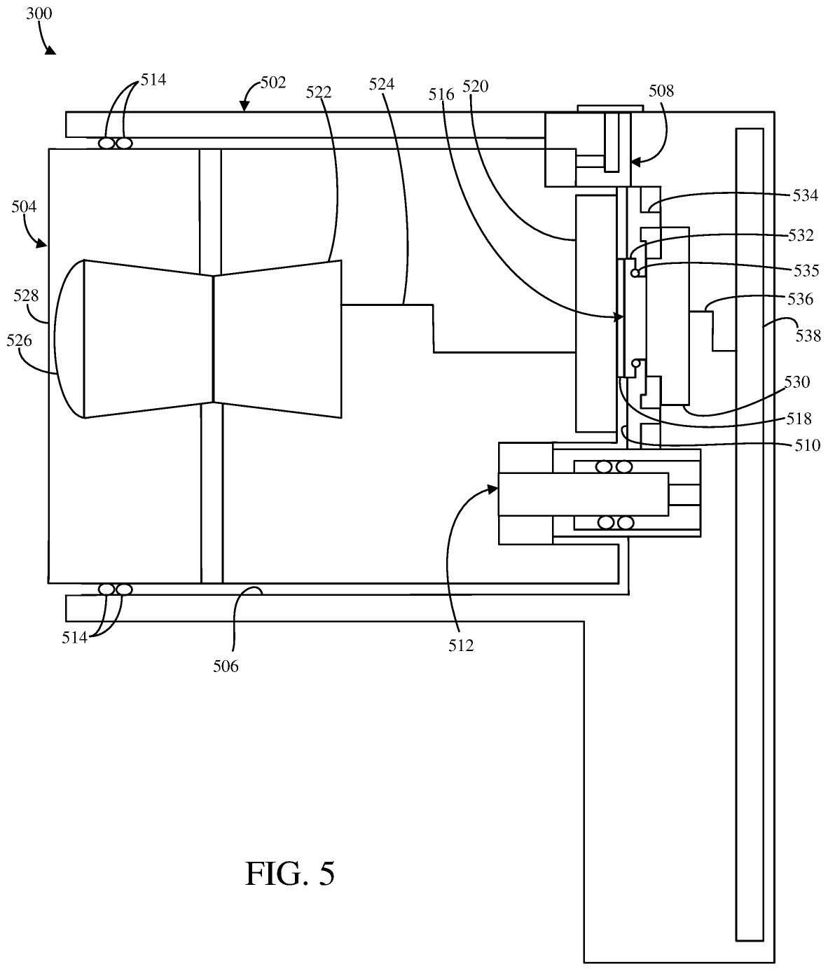

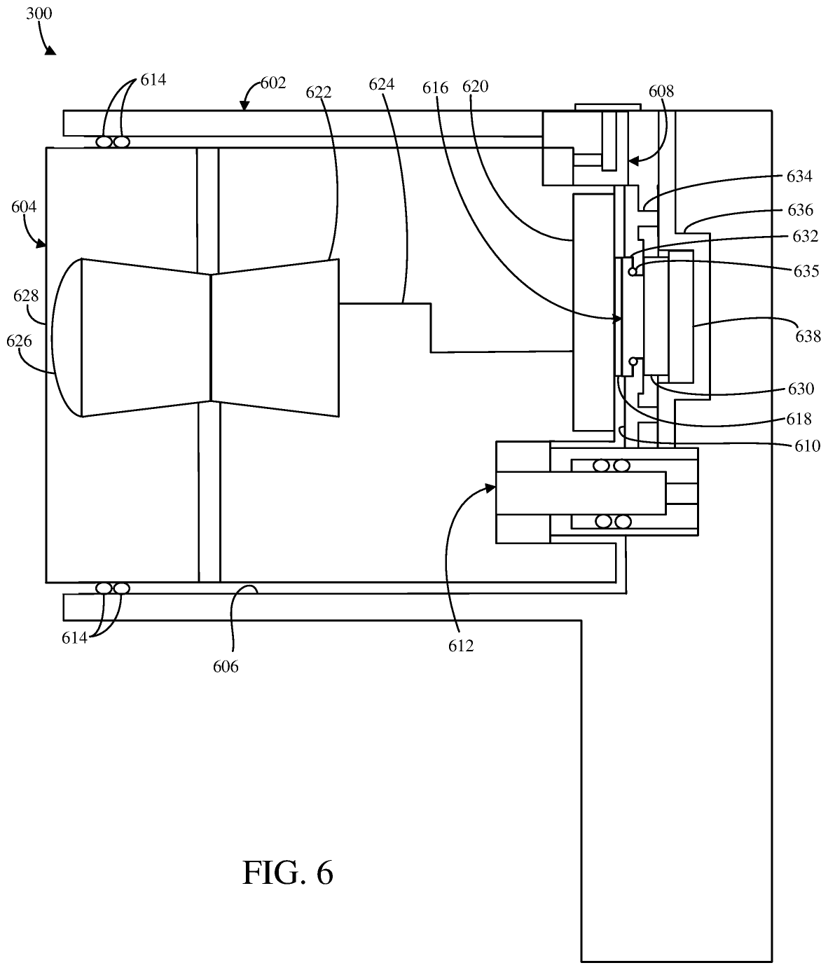

FIG. 5 is a cross-sectional view of another example of a housing 502 and an optic system 504 taken along lines IV-IV of FIG. 3A. The housing 502 includes a receptacle 506 that is configured to receive the optic system 504, and the optic system 504 is securable against the receptacle 506 via a locking feature 508. The locking feature 508 may be any suitable locking means to secure the optic system 504 within the receptacle 506, such as the locking feature 405 of FIG. 4, and may function to secure and retain the optic system 504 against a base 510 of the receptacle 506.

The housing 502 and the optic system 504 communicate via an electrical connection 512, which may be any connection means that allows two electrical components to communicate when connected, such as the input 414 and the output 410 of FIG. 4. Between the housing 502 and the optic system 504, the electrical connection 512 may be used as an indicator that the optic system 504 and the receptacle 506 are desirably aligned such that optimal thermal contact is achieved between the components and an electrical communication is possible. The electrical connection 512 may be similar to the electrical connection 408 of FIG. 4. The housing 502 and the optic system 504 include seals 514 that prevent or mitigate water, moisture, dirt, and/or dust from penetrating the receptacle 506 and interfering with the electrical connection 512 or other components of the housing 502 and/or optic system 504.

At the base 510, the housing 502 includes a heatsink 516 that is configured to regulate heat between the housing 502 and the optic system 504 during operation of the image capture device 300. The heatsink 516 may include some similar components as the heatsink 428 of FIG. 4. The optic system 404 includes a thermal interface 518 that provides a direct thermal connection with the heatsink 516 when the optic system 504 and the receptacle 506 are connected. The thermal interface 518 connects with a heat exchange 520 that is positioned within the optic system 504, and heat exchange 520 is configured to receive heat from an imaging sensor 522 via a conductor 524. The conductor 524, the imaging sensor 522, the heat exchange 520, and/or the thermal interface 518 may be similar as the conductor 426, the thermal interface 432, the imaging sensor 424, and/or the heat exchange 430 of FIG. 4. Additionally, the optic system 504 includes internal and external lenses 526, 528 for allowing the flow of light to the imaging sensor 522 and may include other components that generate heat and are connected to the heat exchange 520 via other conductors (not shown).

The heatsink 516 includes inner and outer supports 530, 532 that surround a gasket 534, which allows the inner and outer supports 530, 532 to rotate relative to an X axis and Y axis (not shown) of the base 510, similarly to how the inner and outer supports 434, 436 rotate relative to the X axis and Y axis of the base 412 of FIG. 4. The inner and outer supports 530, 532 are in thermal communication such that heat coming from the housing 502 or the optic system 504 is transferable between the two larger components. The outer support 532 is in contact with the thermal interface 518 and includes seals 535 so that, while in contact with the thermal interface 518, water and debris does not enter the housing 502. The inner support 530 may be larger than the outer support 532 so that additional heat is dissipated through the inner support 530. Connected with the inner support 530, a conductor 536 facilitates the regulation of heat between the heatsink 516 and an internal component 538 that is configured to dissipate heat. With this configuration, heat from the optic system 504 can be more efficiently dissipated to the internal component 538.

In other examples, the housing 502 may include two or more internal components 538 configured to dissipate heat so that the heat from the optic system 504 can be spread between multiple components of the housing 502. The two or more internal components 538 may be connected with the inner support 530 via one conductor (e.g., the conductor 536) that contacts both of the two or more internal components 538 or two separate conductors (not shown) that each contact the inner support 530 and a different internal component (not shown). The internal component 538 may be a similar material as the heat exchange 520 of the optic system and may have similar functionality, for example, by dissipating heat away from heat generating components to improve operation times of the image capture device 300.

FIG. 6 is a cross-sectional view of another example of a housing 602 and an optic system 604 of FIG. 3A along lines IV-IV. The housing 602 includes a receptacle 606 that is configured to receive the optic system 604, and the optic system 604 is securable against the receptacle 606 via a locking feature 608, which may be similar to the locking features 405, 508 of FIGS. 4 and 5. At a base 610 of the receptacle 606, the housing 602 and the optic system 604 communicate via an electrical connection 612, which be similar to the electrical connections 408, 512 of FIGS. 4 and 5. The housing 602 and/or the optic system 604 include seals 614, which may be similar to the seals 418, 514 of FIGS. 4 and 5.

The housing 602 includes a heatsink 616 that directly transfers thermal energy to or from the optic system 604 via a thermal interface 618. The thermal interface 618 connects to a heat exchange 620 of the optic system 604 and functions to transfer heat from the imaging sensor 622 via the conductor 624. The imaging sensor 622 functions to capture images through internal and external lenses 526, 528, which may have any configuration sufficient to regulate light and protect the imaging sensor 622. The conductor 624 may be a rigid or flexible component that moves heat between the heat exchange 620 and the imaging sensor 622 and may be arranged such that the conductor 624 is free of contact with other internal components (not shown) of the optic system 604. If free of other components, the conductor 624 can move heat from the imaging sensor 622 in an optimal fashion such that minimal heat is lost to other internal components (not shown) before reaching the heat exchange 620.

The heatsink 616 includes inner and outer supports 630, 632 that are connected with a gasket 634 so that the inner and outer supports 630, 632 can rotate, tilt, or translate relative to an X axis and Y axis (not shown), which may be similar to the rotation of the inner and outer supports 434, 436 and gasket 438 relative to the X axis and Y axis of FIG. 4. To increase protection from debris and moisture, seals 635 are included between the gasket 634 and the outer support 632. Behind the inner support 630 and the gasket 634 is a heat exchange 636 that is configured to stabilize the inner and outer supports 630, 632 and dissipate heat that is transferred between optic system 604 and the housing 602.

Between the inner support 630 and the heat exchange 636, a compression member 638 is positioned such that the compression member 638 is deformable as the optic system 604 contacts the heatsink 616 and, concurrently, the compression member 638 provides a force against the inner and outer supports 630, 632 to increase thermal contact between the outer support 632 and the thermal interface 618. The compression member 638 may be any size, shape, or material sufficient to be deformable and provide a force against the inner and outer supports 630, 632. The compression member 638 may deform such that the inner and outer supports 630, 632 are still rotatable relative to the base 610 so that thermal contact is optimally held between the heatsink 616 and the thermal interface 618. The compression member 638 may simply by positioned between the heat exchange 636 and the inner support 630 or the compression member 638 may be adhered the heat exchange 636 and/or the inner support 630, depending how the heat exchange 636 is positioned relative to the base 610 and/or gasket 634. The compression member 638 may be composed of any material that is deformable and/or thermally conductive. Where the heat exchange 636 is not connected to the inner support 630, the compression member 638 acts as a conductor between the inner support 630 and the heat exchange 636, while still providing a force against the inner support 630 when deformed and/or compressed.

The heat exchange 636 functions to dissipate energy from the optic system 604 through any combination of the inner and outer supports 630, 632, the gasket 634, and/or the compression member 638. In FIG. 6, the heat exchange 636 is shown connected with or anchored to the gasket 634, housing 602, and the compression member 638 to support the force applied by the compression member 638 and to dissipate some heat through the housing and/or gasket 634. In other examples, the heat exchange 636 may be connected to any or all of the inner and outer supports 630, 632, and/or the gasket 634 depending on the desired configuration for dissipating heat to or from the optic system 604. For example, the heat exchange 636 may be connected with inner and/or outer supports 630, 632 via a conductor (not shown) so that heat is more efficiently transferred to or from the optic system 604, which improves operation times of the image capture device 300 before overheating.

The heat exchange 636 may have any size or configuration sufficient to support the compression member 638 against the inner support 630 and to dissipate heat from the inner and outer supports 630, 632. For example, as shown in FIG. 6, the heat exchange 636 is larger than the inner and outer supports 630, 632 so that it has a larger mass to dissipate heat, which will improve operation times of the image capture device 300. Where the heat exchange 636 is being used as the main source of dissipating heat, the heat exchange 636 may be as wide or wider and as long or longer as the base 610 of the receptacle 606 to increase its thermal mass. In other examples, the heat exchange 636 may be smaller or equal to the inner and outer supports 630, 632 to reduce the space consumed by the heatsink 616 within the housing 602.

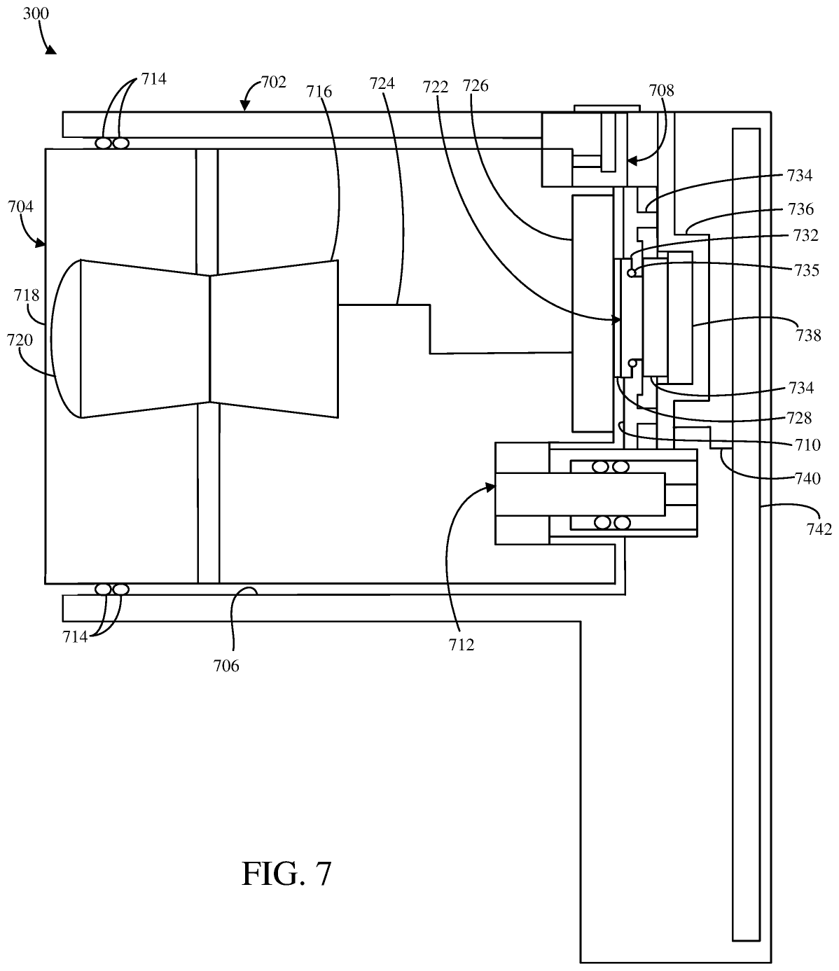

FIG. 7 is a cross-sectional view of another example of a housing 702 and an optic system 704 of FIG. 3A along lines IV-IV. The housing 702 includes a receptacle 706 that is configured to receive the optic system 704, and the optic system 704 is securable against the receptacle 706 via a locking feature 708, which may be similar to the locking features 405, 508, 608 of FIGS. 4-6. At a base 710 of the receptacle 706, the housing 702 and the optic system 704 communicate via an electrical connection 712, which may be similar to the electrical connections 408, 512, 612 of FIGS. 4-6. The housing 702 and the optic system 704 include seals 714, which may be similar to the seals 418, 514, 614 of FIGS. 4-6, that prevent or mitigate water, moisture, dirt, and/or dust from penetrating the receptacle 706 and interfering with the electrical connection 712 or other components of the housing 702 and/or optic system 704.

The optic system 704 includes an imaging sensor 716 that is configured to capture images through lenses 718, 720. The imaging sensor 716, which often generates considerable amounts of heat, is connected with a heatsink 722 by a conductor 724 that extends to a heat exchange 726 and a thermal interface 728, which in combination directly transfer heat between the optic system 704 and the heatsink 722. The conductor 724, the heat exchange 726, and the thermal interface 728 may be similar to the conductors 426, 524, 536, 624, heat exchanges 430, 520, 620 and thermal interfaces 432, 518, 618 of FIGS. 4-6. Additional components may be included in the optic system 704 as appropriate for other functionalities, such as GPS, batteries, sensors, etc., or to improve the heat dissipation qualities of the optic system 704.

The heatsink 722 includes inner and outer supports 730, 732 that are configured to dissipate heat from the optic system through the heat exchange 726 and the thermal interface 728. The inner and outer supports 730, 732 are connected with a gasket 734 such that the inner and outer supports 730, 732 can tilt, rotate, or translate relative to the base 710 and properly align with the thermal interface 728 of the optic system 704. The inner and outer supports 730, 732 and the gasket 734 may be similar to the to the inner and outer supports 434, 530, 630, 436, 532, 632 and the gaskets 438, 534, 634 of FIGS. 4-6. Between the outer support 732 and the gasket 734, seals 735 are included that are configured to prevent entry of debris or moisture into the housing 702, which could interfere with other internal components.

The heatsink 722 can be configured to direct heat towards a heat exchange 736, which may be generally larger than the inner and outer supports 730, 732, so that a significant portion of heat can be directed to the heat exchange 736. For providing a force against the inner support 730, a compression member 738 can be positioned between the inner support 730 and the heat exchange 736, and the force of the compression member 738 is generated as the inner and outer supports 730, 732 are pushed towards the compression member 738 when the optic system 704 comes into contact with the outer support 732. The compression member 738 and the heat exchange 736 may be similar to the heat exchange 636 and the compression member 638 of FIG. 6.

To move heat away from the heat exchange 736, a conductor 740 extends between the heat exchange 736 and an internal component 742 of the housing 702. The internal component 742 is generally configured to dissipate heat away from the optic system 704 to improve operation times of the image capture device before overheating. In other examples, the internal component 742 is configured to move heat from other internal components, such as a battery or a processor, such that heat is more evenly spread throughout the housing 702. The conductor 740 and the internal component 742 may have a similar structures or compositions as the internal component 538 of FIG. 5 and other conductors described herein, such as the conductors 426, 524, 536, 624 of FIGS. 4-6. In some examples, the conductor 740 is configured to move heat to or from other components besides the heat exchange 736 and the internal component 742. For example, the conductor 740 may be connected to another internal component (not shown) and/or a heat generating component (not shown) inside of the housing 702. Where the conductor 740 is connected to another heat generating component, the conductor 740 may move heat from the heatsink 722 and the heat generating component to the internal component 742.

What is claimed is:

1. An image capture device, comprising:
a receptacle defined within a housing;
an optic system configured to removably connect with the receptacle and to generate thermal energy; and
a heatsink positioned at a base of the receptacle, comprising:
an inner support positioned within the housing;
an outer support in thermal communication with the optic system and the inner support; and
a gasket integrated with the receptacle to form a watertight seal, sandwiched between portions of the inner and outer supports, and configured to flexibly retain a physical connection between the optic system and the outer support.

2. The image capture device of claim 1, wherein the receptacle comprises:
a locking feature configured to releasably secure the optic system within the receptacle; and
an electrical connection that is spaced a distance from locking feature, the electrical connection configured to facilitate communication between the housing and the optic system.

3. The image capture device of claim 1, wherein the outer support is configured to regulate thermal energy between the inner support and the receptacle, and wherein the inner support is configured to dissipate thermal energy.

4. The image capture device of claim 1, further comprising:
a heat exchange configured to dissipate thermal energy; and
a compression member in contact with the inner support and configured to provide a force against the heat exchange and/or the inner support.

5. The image capture device of claim 4, further comprising:
a conductor that thermally connects the heat exchange and an internal component that is separated a distance from the heat exchange and is within the housing, the internal component configured to dissipate thermal energy.

6. The image capture device of claim 1, further comprising:
a conductor that thermally connects the inner support and a heat exchange that is separated a distance from the inner support and is within the housing.

7. The image capture device of claim 1, wherein the optic device comprises:
an optical component that is configured to generate thermal energy;
a heat exchange contactable with the outer support; and
a conductor that connects and is configured to regulate thermal energy between the optical component and the heat exchange.

8. The image capture device of claim 7, wherein the optical component comprises an imaging sensor.

9. An image capture device, comprising:
a receptacle configured to receive an optic system that is removable; and
a heatsink that is defined within the receptacle and configured to be in thermal communication with the optic system, comprising:
inner and outer supports that are each in thermal communication with the optic system; and
a gasket positioned between one or more portions of each of the inner and outer supports and configured to force contact between the outer support and the optic system.

10. The image capture device of claim 9, wherein the gasket is integrated with a base of the receptacle to form a watertight seal between the receptacle and an external environment.

11. The image capture device of claim 9, further comprising:
an internal component configured to dissipate thermal energy, positioned within a housing of the image capture device, and spaced a distance from the heatsink; and
a conductor that connects the internal component and the heatsink.

12. The image capture device of claim 9, further comprising:
a heat exchange that is anchored to an internal surface of the receptacle and configured to dissipate thermal energy; and
a compression member in contact with the inner support and the heat exchange, the compression member configured to provide a compression force against the heat exchange and/or the inner support.

13. The image capture device of claim 12, further comprising:
a conductor that connects the heat exchange or the inner support with an internal component, the internal component positioned within a housing of the image capture device, spaced a distance from the heat exchange and the inner support, and configured to dissipate thermal energy.

14. The image capture device of claim 9, wherein the outer support is positioned to contact the optic system and regulate thermal energy between the optic system and the inner support.

15. An image capture device, comprising:
a housing that defines a receptacle;
an optic system removably connected to the receptacle and configured to generate thermal energy; and
a heatsink that is defined within a base of the receptacle, the heatsink configured to provide a compressive force against the optic system when the optic system is connected with the receptacle and to regulate thermal energy between the optic system and the housing.

16. The image capture device of claim 15, wherein the heatsink comprises:
a gasket integrated with the base of the receptacle to form a watertight seal and configured to provide the compressive force against the optic system; and
inner and outer supports that sandwich a portion of the gasket and are configured to regulate thermal energy between the optic system and the housing.

17. The image capture device of claim 16, wherein the heatsink further comprises:
a heat exchange that is in contact with the inner support and is configured to dissipate thermal energy; and
a compression member configured to provide a force against the heat exchange and the inner support when compressed.

18. The image capture device of claim 15, wherein the heatsink is partially exposed to an external environment and is configured to contact the optical system.

19. The image capture device of claim 15, further comprising:
a conductor that extends between the heatsink and an internal component that is spaced a distance from the heatsink within the housing.

20. The image capture device of claim 15, wherein the optic system comprises:
an imaging sensor; and
a conductor that comprises at least one surface that is exposed to the receptacle and that connects the imaging sensor and the heatsink.
